(19) United States
(12) Patent Application Publication
(10) Pub. No.: US 2004/0241285 A1
(43) Pub. Date: Dec. 2, 2004

(54) Method for the production of oily suspensions of water-soluble enzymes

(76) Inventors: Andreas Habich, Speyer (DE); Frank Runge, Friedelsheim (DE); Jorg Braun, Offenbach (DE); Preben Soerensen, Ludwigshafen (DE); Wolfgang Heinzl, Wachenheim (DE)

Correspondence Address: Morrison & Foerster, Suite 300, 1650 Tysons Boulevard, McLean, VA, 22102-3915, US

(21) Appl. No.: 10/490,437

(22) PCT Filed: Sep. 14, 2002
(86) PCT No.: PCT/EP02/10321

(30) Foreign Application Priority Data
Sep. 25, 2001 (DE) 10147035.5

(51) Int. Cl. A23L 1/28

(52) U.S. Cl. 426/61

(57) ABSTRACT

A description is given of oily suspensions of at least one water-soluble enzyme and of a process for preparing these suspensions and of their use as additive to animal feeds.

The invention relates to oily suspensions of at least one water-soluble enzyme and to a process for preparing these suspensions and to their use as additive to animal feeds.

Adding water-soluble enzymes to feeds is performed in the prior art as solid, as granules or extrudate, before pelleting the feed mixture.

This has the disadvantage that, to achieve sufficient pelleting stability at relatively high pelleting temperatures, application of coatings to the granule or extrudate is necessary in an additional process step.

In addition, liquid aqueous formulations of water-soluble enzymes can be applied after pelleting by spraying onto the feed pellets.

These aqueous formulations are commercially available or can be directly produced from instant powders by dissolution in water.

Aqueous formulations generally have disadvantageous microbiological stability and low storage stability.

JP 09 322 770 describes stable enzyme-in-oil dispersions and their use for tenderizing meat.

It an object of the present invention, therefore, to provide stable liquid formulations of water-soluble enzymes which do not have the abovementioned disadvantages of the prior art.

We have found that this object is achieved according to the invention by a process for preparing oily suspensions of water-soluble enzymes, which comprises, in the absence of water-soluble vitamins

a) grinding at least one water-soluble enzyme in an oil, preferably in at least one edible oil, to a mean particle size of from 0.1 to 100 μm or

b) grinding at least one water-soluble enzyme without using a continuous phase to a mean particle size of from 0.1 to 100 μm and then suspending the ground particles in an oil, preferably in at least one edible oil.

The water-soluble vitamins are, in particular, ascorbic acid and its salts, such as sodium ascorbate, and vitamin C derivatives such as sodium, calcium or magnesium ascorbyl-2-monophosphate or calcium ascorbyl-2-polyphosphate, calcium pantothenate, panthenol, vitamin B₁ (thiamin) as hydrochloride, nitrate or pyrophosphate, vitamin B₂ (riboflavin) and its phosphates, vitamin B₆ and salts, vitamin B₁₂, biotin, folic acid and folic acid derivatives such as tetrahydrofolic acid, 5-methyltetrahydrofolic acid, 5-formyltetrahydrofolic acid, nicotinic acid and nicotinamide.

A water-soluble vitamin in this context is also vitamin K₃ (menadione) as sodium bisulfite.

The water-soluble enzymes are, in particular, oxidoreductases, transferases, lyases, isomerases, ligases and hydrolases. Preferred enzymes are hydrolases. Examples of hydrolases, that is to say enzymes catalyzing hydrolytic cleavage of chemical bonds, are esterases, glycosidases, lipases, phospholipases, ether hydrolases, proteases, amidases, amimidases, nitrilases and phosphatases.

Glycosidases comprise not only endo- but also exo-glucosidases, which cleave not only α- but also β-glycosidic bonds. Typical examples of these are: amylases, maltases, cellulases, endo-xylanases, β-glucanases, mannanases, lysozymes, galactosidases, β-glucuronidases, glucose oxidases, saccharases, lactases and the like.

Preference is given in particular to enzymes cleaving non-starch polysaccharides, for example, amylase, glucanase and xylanase, and phosphatases, such as in particular phytase.

In the inventive process the water-soluble enzymes can also be used as a combination of the described enzymes.

The embodiments described hereinafter therefore always also relate to the combination of water-soluble enzymes.

The abovementioned water-soluble enzymes can, before grinding, be in any desired solid form. These solids can be prepared in a manner known per se, for example, from culture broths by drying or precipitation processes. Preferably, these culture broths, before the drying or precipitation, are filtered or centrifuged. Drying processes are, for example, spray-drying, fluidized-bed drying or contact drying, in particular freeze-drying.

The precipitation processes are known per se, for example precipitation by adding Na₂SO₄. Precipitation methods are described, for example, in “Enzyme der Tierernährung [Enzymes in animal nutrition], AWT, 1997, Roonstrasse 53175 Bonn”.

Accordingly, the water-soluble enzymes can be in the form of, for example, powders, granules or lyophilizates.

Preferably, the water-soluble enzymes, before the grinding, are used as solids which have a water content of less than 10% by weight.

Edible oils which can be used are generally all physiologically acceptable oils, not only of plant origin but also of animal origin, in particular those oils which are liquid at 20° C. or which, in the suspension at 20° C., form the liquid phase alone or together with other oils. Those which may preferably be mentioned in this context are sunflower seed oil, palm oil, sesame oil, corn germ oil, cottonseed oil, soybean oil or peanut oil, esters of medium-chain triglycerides and, in addition, fish oils, for example mackerel oil, sprat oil or salmon oil. Those which are particularly preferred for animal nutrition are fish oils, corn germ oil, sunflower seed oil and peanut oil. In addition, those which are advantageous for the food/pharmaceutical sector are the esters of medium-chain triglycerides.

An edible oil in the context of the invention is also vitamin E, vitamin E derivatives or mixtures thereof. The term vitamin E in this context represents natural or synthetic α-, β-, γ- or δ-tocopherol, preferably natural or synthetic α-tocopherol, and tocotrienol. Vitamin E derivatives are, for example, tocopheryl C₁-C₂₀-alkanoic esters, such as tocopheryl acetate or tocopheryl palmitate.

Vitamin E and/or its derivatives can be used alone or together with other edible oils as dispersion medium.

The grinding can be performed in a manner known per se, for example using a ball mill. Depending on the type of mill used, grinding is performed until the particles have a mean particle size D[4,3] of from 0.1 to 100 μm, preferably from 0.2 to 80 μm, particularly preferably from 0.5 to 50 μm, very particularly preferably from 0.8 to 40 μm, for example measured via Fraunhofer diffraction. The term D[4,3] designates the volume-weighted mean diameter (see Handbook for the Malvern Mastersizer S, Malvern Instruments Ltd., UK).

It can be advantageous, in the case of large solids, to carry out a pregrinding of the enzyme solids.

Further details on grinding and the apparatus used therefor may be found, inter alia, in Ullmann's Encyclopedia of Industrial Chemistry, Sixth Edition, 1999, Electronic Release, Size Reduction, Chapter 3.6.: Wet Grinding.

In the inventive grinding process it is possible to grind all of the components used in the suspension as a total mixture. However, each individual component to be ground can also be ground at high concentration in the oil to be used. The final preparation is then produced by mixing the respective individual suspensions.

The inventive preparation can be diluted to the respective service concentration using fats or oils.

In a particular embodiment of the inventive process, the grinding in step a) and the grinding and/or suspension in step b) is performed in the absence of an emulsifier.

In a further advantageous embodiment of the inventive process, the grinding in step a) and the grinding and/or suspension in step b) is carried out in the absence of a protective colloid.

Despite the absence of the abovementioned dispersants and formulation aids, the inherently hydrophilic enzymes can be very finely ground without wetting problems or agglomerate formation in the abovementioned hydrophobic dispersion media, which is unexpected to those skilled in the art.

In addition to the above-described wet grinding, the inventive oily suspensions may also be prepared by dry grinding the water-soluble enzymes and subsequently suspending the ground particles in at least one edible oil. Dry grinding in this context is grinding without using a continuous phase.

Further details on dry grinding may be found, inter alia, in Ullmann's Encyclopedia of Industrial Chemistry, Sixth Edition, 1999, Electronic Release, Size Reduction, Chapter 3.4.

It has proved to be of particular advantage with respect to the stability of the inventive oily dispersions if the grinding in process step a) and the grinding and/or suspension in step b) are carried out in the presence of desiccants. Preference is given here to desiccants selected from the group consisting of alkali metal sulfates and alkaline earth metal sulfates, such as sodium, calcium and magnesium sulfate, alkali metal chlorides and alkaline earth metal chlorides, such as sodium, calcium and magnesium chloride, and silica gel. A very particularly preferred desiccant is CaCl₂.

The amount of desiccant used is generally from 0.1 to 20% by weight, preferably from 0.5 to 15% by weight, particularly preferably from 1.0 to 10% by weight, based on the total amount of oily suspension.

The desiccant or desiccants used can also be ground separately, as in process step a), in an edible oil and then added to the oily suspension of the ground water-soluble enzymes. In addition, it is possible to mix the desiccants even unground with the oily suspension of the ground water-soluble enzymes from process step a). In the case of dry grinding, the water-soluble enzymes and the desiccant or desiccants can also be ground separately and then added to the oily suspension.

It has surprisingly been found that adding desiccants decreases the viscosity of the oily suspension compared with desiccant-free oily suspensions.

Owing to the finely divided distribution of the dispersed water-soluble enzymes, the oily suspensions prepared by the inventive process feature a high bioavailability of the active compounds present in the suspension.

In addition to the water-soluble enzymes mentioned at the outset, before, during or after grinding, additional fat-soluble vitamins, for example, the K vitamins, vitamin A and derivatives such as vitamin A acetate, vitamin A propionate or vitamin A palmitate, vitamin D₂ and vitamin D₃ and the previously mentioned E vitamins, can be introduced into the oily suspension and dissolved. Preferably, the grinding in step a) and the suspension in step b) are performed in the presence of fat-soluble vitamins.

The invention also relates to oily suspensions of at least one water-soluble enzyme, obtainable by the inventive process described above.

The inventive oily suspensions comprise, in very finely ground form, from 1 to 70% by weight, preferably from 2 to 60% by weight, particularly preferably from 10 to 55% by weight, very particularly preferably from 15 to 50% by weight, of at least one of the water-soluble enzymes mentioned at the outset.

Moreover, the oily suspensions can additionally comprise, in dissolved form, from 0.5 to 60% by weight, preferably from 5 to 50% by weight, particularly preferably from 10 to 45% by weight, very particularly preferably from 15 to 40% by weight, of at least one of the fat-soluble vitamins mentioned at the outset.

Furthermore, the oily preparations can additionally comprise at least one further carotinoid.

Carotinoids are, for example, the following compounds: β-carotene, lycopene, lutein, astaxanthin, zeaxanthin, cryptoxanthin, citranaxanthin, canthaxanthin, bixin, β-apo-4-carotenal, β-apo-8-carotenal, β-apo-8-carotinic esters, individually or as a mixture. Carotinoids preferably used are β-carotene, lycopene, lutein, astaxanthin, zeaxanthin, citranaxanthin and canthaxanthin.

The carotinoids can be used in crystalline form or as a formulation, for example as dry powder in accordance with EP-A-0 065 193.

Advantageously, the carotinoids are generally ground in crystalline form together with the water-soluble enzymes in the oil. In the case of astaxanthin and canthaxanthin, preferably, astaxanthin- or canthaxanthin-containing dry powders, for example Lucantin® Pink or Lucantin® Red (a 10% astaxanthin or canthaxanthin dry powder, from BASF Aktiengesellschaft, Ludwigshafen, Germany), are used together with the water-soluble enzymes.

The carotinoid content in the formulations is generally from 0.1 to 40% by weight, preferably from 0.3 to 20% by weight, particularly preferably from 0.5 to 10% by weight, very particularly preferably from 1 to 5% by weight, based on the total amount of formulation.

Depending on the application, the inventive oily preparations can comprise up to 10% by weight of other additive components, for example minerals, amino acids, proteins or fat-soluble enzymes.

These additives, just as in the case of the above-mentioned fat-soluble vitamins and carotinoids, can be added before, during or after the grinding of the inventive suspension. In order to obtain a very finely divided homogeneous suspension of all non-oil-soluble constituents, it is also advantageous to grind the abovementioned constituents together with the water-soluble enzymes.

Minerals which can be incorporated into the suspension and co-ground are, for example, iron sulfate, zinc sulfate, manganese sulfate, copper sulfate, calcium sulfate, sodium sulfate, copper oxide, magnesium oxide, calcium fluoride, potassium chloride, potassium iodide, sodium chloride, calcium iodate, calcium phosphate, magnesium phosphate, potassium phosphate, sodium phosphate or iron phosphate, cobalt carbonate, sodium selenate or silicic acid and its salts. The amount of minerals used, for example in the animal nutrition sector, will depend in each case on the requirements of the animals to be fed.

Amino acid residues which can be used are generally all known physiologically acceptable α-amino acid residues. Those which may preferably be mentioned are the residues of the following amino acids: alanine, arginine, asparagine, aspartic acid, cysteine, cystine, glutamine, glutamic acid, glycine, histidine, isoleucine, leucine, lysine, methionine, phenylalanine, hippuric acid, serine and taurine. Those which are particularly preferred are lysine, methionine and cysteine.

Further constituents of the suspension may be:

compounds having vitamin or coenzyme character, for example choline chloride, carnitine, γ-butyrobetaine, lipoic acid, creatine, ubiquinones, S-methylmethionine, S-adenosylmethionine.

Polyunsaturated fatty acids, for example linoleic acid, linolenic acid, arachidonic acid, eicosapentaenoic acid, docosahexaenoic acid.

Feed antibiotics for medicated feed and microorganisms to improve digestion.

In some cases it may be necessary for the oily suspensions additionally to comprise auxiliaries, for example protective colloids, antioxidants, thickeneers, chelating agents, for example alkali metal salts or alkaline earth metal salts of citric acid, phytic acid or phosphoric acid and/or emulsifiers.

Protective colloids which can be used are, for example, gelatin, fish gelatin, starch, dextrin, plant proteins, pectin, gum arabic, casein, caseinate or mixtures thereof. However, polyvinyl alcohol, polyvinylpyrrolidone, methyl cellulose, carboxymethyl cellulose, hydroxypropyl cellulose and alginates can also be used. For more details, reference is made to R. A. Morton, Fat Soluble Vitamins, Intern. Encyclopedia of Food and Nutrition, Vol. 9, Pergamon Press 1970, pp. 128-131.

To increase the stability of the active compound to oxidative breakdown it is advantageous to add stabilizers such as α-tocopherol, tertiary butylated hydroxytoluene, tertiary butylated hydroxyanisole or ethoxyquin.

Emulsifiers or solubilizers which can be used are, for example, polyglycerol esters of fatty acids, sorbitan esters of fatty acids, propylene glycol esters of fatty acids or lecithin.

The suspensions are suitable, inter alia, as additive in animal feed preparations and in mixed feed and for producing food supplements in the animal sector.

Preferably, the suspensions may be used as feed additive in animal nutrition, preferably for application or spraying onto feed pellets, particularly preferably for admixing to feed mixtures before pelleting.

They are used as feed additive, in particular, by direct spraying of the inventive suspensions, if appropriate after dilution with oils, for example onto animal feed pellets in what is called post-pelleting application.

A preferred embodiment of the spraying process is that wherein the feed pellets are charged with the oily suspension under reduced pressure.

Examples of this may be found, inter alia, in GB-A-2 232 573 and in EP-A-0 556 883.

Preferably, the invention is directed to animal feeds, in particular to feed pellets which are charged with the suspensions or to which the suspensions are added in desired combinations before pelleting the feed mixturess.

The oily suspensions which can be prepared by the inventive process have the advantage of increased storage stability and reduced susceptibility to microbiological infestation.

In addition, the oily suspensions can be added directly to the feed mixtures before pelleting without the complex process step of coating.

The example below describes the preparation of the inventive oily suspensions of water-soluble enzymes in more detail.

### EXAMPLE 1

Two kilograms of a mixture of 25% by weight of dried phytase (from Aspergillus, spray-dried) and 75% by weight of corn germ oil are stirred with a blade agitator until a homogeneous suspension is obtained. The mixture is then transferred to a stirrable reservoir from which the suspension is transported by means of peristaltic pump through a continuously operated ball mill (Dyno Mill KDL Spezial). The grinding vessel of the ball mill is filled with 400 g of glass balls (diameter from 800 to 1200 μm). The finely divided suspension exiting from the mill is collected and measured using a particle size measuring instrument (Malvern Mastersizer). The grinding operation is repeated until the suspended particles have a mean particle size of less than 20 μm.

1. A process for preparing oily suspensions of water-soluble enzymes, which comprises, in the absence of water-soluble vitamins, grinding at least one water-soluble enzyme in an oil to a mean particle size of from 0.1 to 100 mm.

2. The process of claim 1, wherein the oil is an edible oil.

3. The process of claim 1, wherein the oil is an oil liquid at 20° C.

4. The process of claim 2, wherein the edible oil is vitamin E, vitamin E derivatives or mixtures thereof.

5. The process of claim 1, wherein the grinding is carried out in an absence of an emulsifier.

6. The process of claim 1, wherein the grinding is carried out in an absence of a protective colloid.

7. The process of claim 1, wherein the at least one water-soluble enzyme is a solid having a water content of less than 10% by weight.

8. The process of claim 1, wherein the grinding is carried out in a presence of a fat-soluble vitamin.

9. The process of claim 1, wherein the grinding is carried out in a presence of a desiccant.

10. The process of claim 9, wherein the desiccant is selected from the group consisting of alkali metal sulfates, alkaline earth metal sulfates, alkali metal chlorides and alkaline earth metal chlorides, silica gel, and combinations thereof.

11. An oily suspension comprising at least one water-soluble enzyme, obtainable by the process of claim 1.

12. The oily suspension of claim 11 comprising from 1 to 70% by weight of the at least one water-soluble enzyme.

13. The oily suspension of claim 11, additionally comprising from 0.5 to 60% by weight of at least one fat-soluble vitamin.

14. A method for forming feeds for animals comprising adding the oily suspension of claim 11 to an animal feed.

15. A method for providing nutrition to an animal comprising providing the oily suspension of claim 11 to said animal.

16. The method of claim 14 wherein the animal feed comprises feed pellets.

17. The method of claim 16, wherein the oily suspension is admixed with the animal feed before pelleting.

18. The method of claim 16, wherein the feed pellets are charged with the oily suspension under reduced pressure.

19. A feed pellet comprising the oily suspension of claim 11.

20. The process of claim 1, wherein the oily suspension is prepared in an absence of a wetting problem.

21. The process of claim 20, wherein the wetting problem is agglomerate formation.

22. The oily suspension of claim 11, which has an increased storage stability and a reduced susceptibility to microbiological infestation.

23. The method of claim 16, wherein adding comprises spraying said oily suspension onto said feed pellets.

24. A process for preparing oily suspensions of water-soluble enzymes, which comprises, in the absence of water-soluble vitamins, grinding at least one water-soluble enzyme without a continuous phase to a mean particle size of from 0.1 to 100 mm and suspending the ground particles in an oil.

25. The process of claim 24, wherein the oil is an edible oil.

26. The process of claim 25, wherein the edible oil is vitamin E, vitamin E derivatives or mixtures thereof.

27. The process of claim 24, wherein the oil is an oil liquid at 20° C.

28. The process of claim 24, wherein the grinding is carried out in an absence of an emulsifier.

29. The process of claim 24, wherein the grinding is carried out in an absence of a protective colloid.

30. The process of claim 24, wherein the at least one water-soluble enzyme is a solid having a water content of less than 10% by weight.

31. The process of claim 24, wherein the grinding is carried out in a presence of a fat-soluble vitamin.

32. The process of claim 24, wherein the grinding is carried out in a presence of a desiccant.

33. The process of claim 32, wherein the desiccant is selected from the group consisting of alkali metal sulfates, alkaline earth metal sulfates, alkali metal chlorides, alkaline earth metal chlorides, silica gel, and combinations thereof.

34. The process of claim 24, wherein the oily suspension is prepared in an absence of a wetting problem.

35. The process of claim 34, wherein the wetting problem is agglomerate formation.

36. An oily suspension comprising at least one water-soluble enzyme obtainable by the process of claim 24.

37. The oily suspension of claim 36 comprising from 1 to 70% by weight of the at least one water-soluble enzyme.

38. The oily suspension of claim 36, additionally comprising from 0.5 to 60% by weight of at least one fat-soluble vitamin.

39. The oily suspension of claim 36, which has an increased storage stability and a reduced susceptibility to microbiological infestation.

40. A feed pellet comprising the oily suspension of claim 36.

41. A method for providing nutrition to an animal comprising providing the oily suspension of claim 36 to said animal.

42. A method for forming feeds for animals comprising adding the oily suspension of claim 36 to an animal feed.

43. The method of claim 42, wherein the animal feed comprises feed pellets.

44. The method of claim 43, wherein the oily suspension is admixed with the animal feed before pelleting.

45. The method of claim 43, wherein adding comprises spraying said oily suspension onto said feed pellets.

46. The method of claim 43, wherein the feed pellets are charged with the oily suspension under reduced pressure.
